(19) United States
(12) Patent Application Publication
(10) Pub. No.: US 2009/0031416 A1
(43) Pub. Date: Jan. 29, 2009

(54) Authenticating a Computer Device at the User Level

(75) Inventors: Stanislas Francfort, Evrecy (FR); Jean-Marc Hospital, Paris (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/224,799

(22) PCT Filed: Mar. 6, 2007
(86) PCT No.: PCT/FR2007/050885

§ 371 Date: Sep. 5, 2008

(30) Foreign Application Priority Data
Mar. 7, 2006 (FR) 0602019

(51) Int. Cl. G06F 21/00

(52) U.S. Cl. 726/16

(57) ABSTRACT

The invention concerns authentication of a user device (10) performed at a user level (13, 14, 12). Based on a known association of the user with at least one sensory content at the user level and at the computer device level, it consists in determining at the device level, a digital content level based on a sensory content associated with the user; then in providing (203) at the user level the digital content thus determined; authenticating the computer device by comparing the sensory content associated with the user to the digital content provided at the user level.

The present invention relates to security in the field of computing and, more precisely, authenticating a computer device at the user level.

In order to authenticate a first computer device by a second computer device in a telecommunications network, numerous cryptographic authentication methods are known. These methods are generally based on an exchange of messages between the two computer devices. The first computer device can for example send to the second computer device a question to which only the second computer device is able to respond. Under these conditions, if the second computer device responds to the question put, the first computer device is then assured that it is not communicating with a rogue third party machine.

In order to authenticate a user, i.e. a human, by a networked computer device, methods of authentication by password are commonly used. These methods are widespread, in particular in the field of banking applications, in the field of mobile telephony, as well as in the field of electronic mailboxes. However, such methods are vulnerable to a fraud technique based on ‘replay’ of the authentication characteristics, i.e. that a fraudster, having captured the password, can replay it and thus usurp the identity of a user in order to fraudulently identify himself.

In the field of the authentication of a computer device at the user level, it is possible to apply either one of the types of methods mentioned above.

When it is intended to apply a cryptographic authentication method, the complexity of the cryptographic calculations to be carried out can pose a major problem for the user authenticating a computer device. It is then possible to associate with the user, a machine capable of performing such calculations. Thus, in particular networks based on an architecture of the PKI (Public Key Infrastructure) type, in which a local machine, having the full confidence of the user, carries out the complex cryptographic calculations which are required for the user-side authentication of a computer device. In this type of network, a digital certificate plays the role of an electronic identity card which can guarantee the identity of a computer device, such as a server to which the user connects. A certificate of this type comprises a public key which is signed by a certification authority. Thus, in this context, it is the responsibility of the user to verify the authenticity of the public key of the certification authority which delivered the server's certificate. This step of verifying the authenticity is not user-friendly and its implementation is still very often unclear to the user. The result is that such a step is rarely undertaken.

When it is envisaged to apply password methods of authentication in the field of authentication of a computer device at the user level, an attack can be carried out based on a replay of the authentication characteristics, as described previously. Moreover, it does appear to be easy for a human user to verify a password of a computerized device, as the latter can have a high level of complexity.

As a result, the methods of authentication of a computer device by a user have major drawbacks, even though these methods can be very important, in particular in the service field. In fact, they can make it possible to improve the security of services offered to their users, by inserting a user-level device authentication step.

Indeed, in telecommunications networks like the Internet for example, some servers require their users to give confidential information. This is the case in particular for the servers offering banking services. Thus, when a user connects to a server to use a banking service, via a user terminal such as a personal computer for example, he generally sees on his computer screen, a web page including a field provided to accept a password. The user is then prompted to supply the confidential information in order to connect to such a service.

Under these conditions, a user can supply confidential information to a rogue server which is not authorized to receive such information. In fact, in the case where a rogue server sends a web page similar to the web page issued by the server authorized to offer banking services, the user is not able to detect that the page viewed on his computer screen is in fact sent by a rogue server. The user can then be prompted, during this connection to a rogue server, to supply confidential information which can subsequently be used for the fraudulent purposes.

The present invention aims to overcome the drawbacks of the authentication methods of a computer device at the user level.

A first aspect of the present invention proposes a method for authenticating a computer device at the user level. It is intended to associate at least one sensory content with the user, this association being known on the one hand at the user level and on the other hand at the level of the computer device. The method can comprise the following steps:
/a/ at the level of the computer device, determining a digital content using the sensory content associated with said user;
/b/ from the computer device, providing at the user level the digital content determined in step /a/;
/c/ deciding to authenticate the computer device by comparing the sensory content associated with said user, with the digital content supplied in step /b/.

In an advantageous embodiment, the computer device manages a determination parameter which develops according to a rule known at the user level. Step /a/ can furthermore be carried out using this determination parameter and step /c/ can furthermore be carried out using said development rule of the determination parameter.

In step /a/, the digital content can be determined by combining the determination parameter with the sensory content associated with the user. In this case, in step /b/, the determination parameter and the sensory content can be supplied separately; and

step /c/ can be carried out using on the one hand the determination parameter and on the other hand the sensory content provided in step /b/.

The determination parameter can be a time reference which develops according to a rule based on a known time clock at the level of the computer device and at the user level.

Associating the user with a plurality of sensory contents can be envisaged. In step /a/, the digital content can then be determined by selecting a sensory content from the plurality of sensory contents according to a selection rule based on the determination parameter, the selection rule being known at the level of the computer device and of the user; and step /c/ can moreover be carried out using said selection rule.

When a telecommunications network links the computer device to the user level via a user terminal and when a secret cryptographic characteristic is known on the one hand at the user level and on the other hand at the level of the computer device, then in step /b/, the following steps can be carried out:
encrypting the digital content determined using the cryptographic characteristic and then sending the encrypted digital content from the computer device to user terminal;
decrypting said received encrypted digital content at the user terminal, using the cryptographic characteristic; and
from the user terminal, providing at the user level, digital content obtained in the previous step.

When the computer device manages a determination parameter developing according to a rule known at the user level, step /a/ can be carried out by combining the determination parameter with the associated sensory content in a concealed manner according to a stenographic-type method and step /c/ can be carried out using the development rule of the determination parameter. Under these conditions, the decryption step carried out by the user terminal can comprise a detection of the determination parameter within the combined sensory content in order to provide the decrypted sensory content and the determination parameter separately at the user level.

The sensory content can be chosen from a group comprising an image, a sequence of images, an audio content and an audiovisual content.

A second aspect of the present invention proposes a computer device to be authenticated at the user level and comprising:
a memory for storing said association;
a determination unit capable of determining a digital content using the sensory content associated with said user;
a transmission unit capable of providing, at the user level, the digital content determined by said determination unit.

This computer device can manage a determination parameter developing according to a rule known at the user level. Then, the determination unit can advantageously determine a digital content also using this determination parameter.

The determination unit can determine a digital content by combining the determination parameter with the sensory content associated with the user so as to allow a distinction between the determination parameter and the sensory content at the user level.

If an association is provided between the user and a plurality of sensory contents, the determination unit is capable of determining the digital content by selecting a sensory content from said plurality of sensory contents according to a selection rule based on the determination parameter, the selection rule being known at the level of the computer device and the user.

When a telecommunications network links the computer device to the user level via a user terminal and when a secret cryptographic characteristic is known, on the one hand at the user level and on the other hand at the level of the computer device, the transmission unit can comprise:
means of encryption capable of encrypting the determined digital content, using the cryptographic characteristic;
means of transmission capable of sending the encrypted digital content from the computer device to user terminal.

When a determination parameter developing according to a rule known at the user level is managed by the device, the determination unit can be capable of determining the digital content by combining the determination parameter with the associated sensory content in a concealed manner according to a stenographic-type method.

A third aspect of the present invention proposes a computer server which is capable of providing at least one service to a user, and which comprises a device according to the second aspect of the present invention.

A fourth aspect of the present invention proposes a user interface management unit linked to a device according to the second aspect of the present invention, the user interface management unit being capable of receiving a determined digital content from the computer device, using the sensory content associated with the user, in order to provide this digital content to the user in the form of a sensory content.

A fifth aspect of the present invention proposes a user terminal in an authentication system of a computer device at the user level; the computer device being linked to the user terminal by a telecommunications network; an association of the user with at least one sensory content and a secret cryptographic characteristic, both being known on the one hand at the user level and on the other hand at the level of the computer device. The user terminal comprises:
a decrypting unit capable of decrypting a digital content in encrypted form received from the computer device, using the cryptographic characteristic; and
a user interface management unit capable of providing the user with the digital content decrypted by the decrypting unit, in the form of a sensory content.

When the computer device manages a determination parameter developing according to a rule known at the user level, and when the user terminal receives a digital content resulting from a combination, of the determination parameter and the sensory content associated with the user carried out in a concealed manner according to a stenographic-type method, this user terminal can comprise means capable of providing the decrypted sensory content and the determination parameter separately at the user level.

A sixth aspect of the present invention proposes a system for authenticating a computer device at the user level according to the second aspect of the present invention.

Such an authentication system can also comprise an interface management unit according to the fourth aspect of the present invention.

Such an authentication system can also comprise an interface management unit according to the fifth aspect of the present invention.

A seventh aspect of the present invention proposes a computer software product to be installed in a computer device (10), comprising instructions capable of implementing the method according to the first aspect of the present invention, during an execution of the programme by the processing means of the computer device.

Other aspects, aims and advantages of the invention will become apparent on reading the description of one of its embodiments.

The invention will also be better understood using the drawings, in which:

FIG. 1 illustrates an architecture of an authentication system according to an embodiment of the present invention;

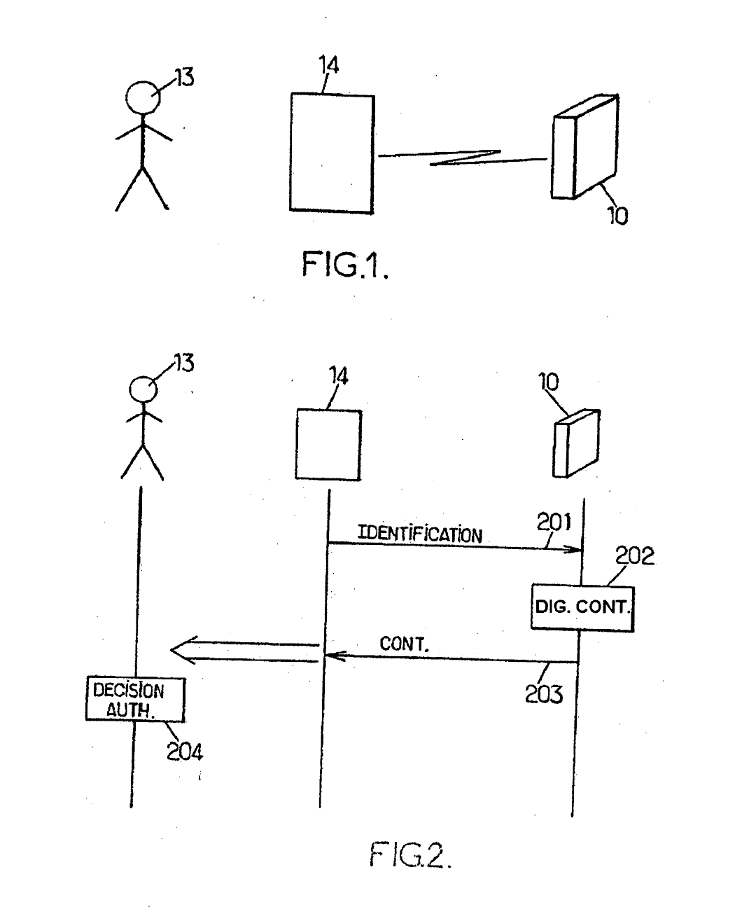

FIG. 2 illustrates an exchange of information carried out during an authentication according to an embodiment in a system such as the one represented in FIG. 1;

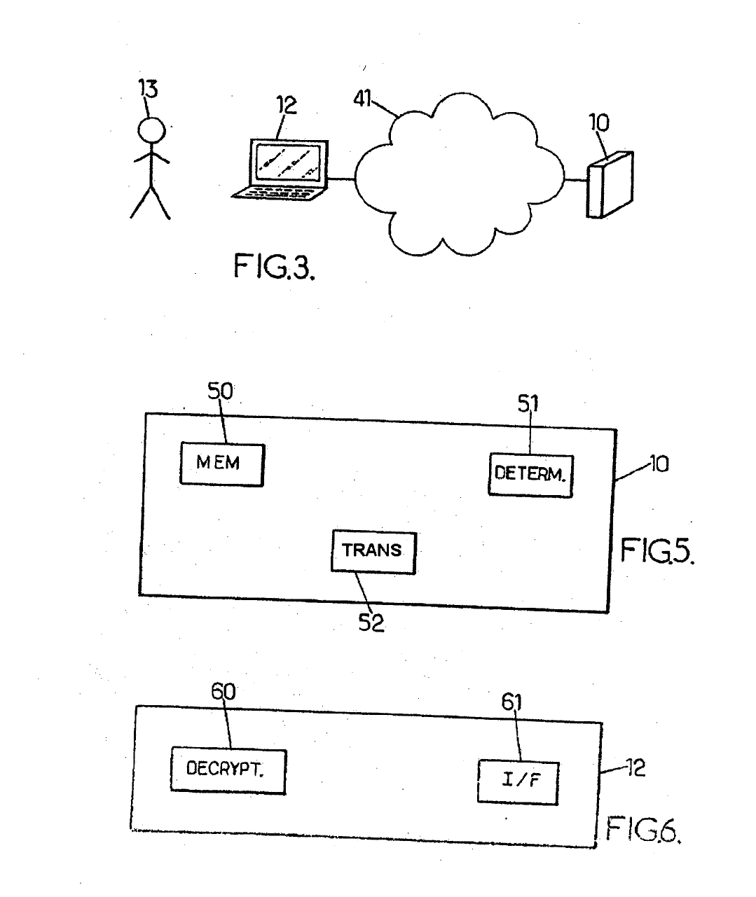

FIG. 3 illustrates an architecture of an authentication system according to an embodiment of the present invention;

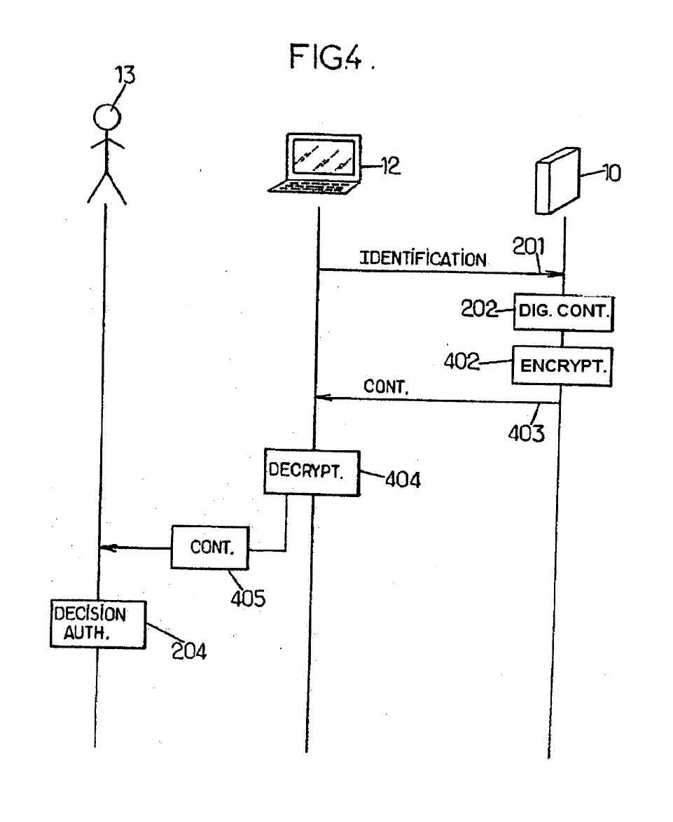

FIG. 4 illustrates an exchange of information carried out during an authentication according to an embodiment in a system such as the one represented in FIG. 3;

FIG. 5 illustrates a computer device to be authenticated according to an embodiment of the present invention;

FIG. 6 illustrates a user terminal capable of implementing a method of authentication according to an embodiment of the present invention.

An objective of the present invention is to propose a method allowing a user to authenticate a computer device in an efficient and user-friendly manner, to be assured that the computer device with which he exchanges information, optionally confidential information, corresponds to the computer device with which he wishes to exchange such information.

An embodiment of the present invention is based on the fact that a sensory content is known only on the one hand, at the user level, and on the other hand, at the level of the computer device to be authenticated. Thus, during such an authentication, the sensory content is received at the user level. It is then compared with the expected user-side sensory content, in order to take a decision concerning the authentication of the computer device considered. If the received sensory content matches that expected at the user level, the computer device is then authenticated.

Advantageously, it can be arranged that the computer device to be authenticated provides the user with this sensory content via secure delivery means, for example using a registered letter. It is also possible to arrange for the secret sensory content associated with the considered user to be defined at the user level. In this case, this sensory content is then sent via secure transmission channels to the destination computer device to be authenticated.

Instead of transmitting all the sensory content, either from the computer device to the user side, or from the user side to the computer device, it can be advantageous in certain contexts to transmit simply a reference to the considered sensory content, rather than transmitting the sensory content itself. Thus, when the sensory content is commonly known, such as for example a representation of an orchid or even a painting by a classical artist, a reference to the sensory content will preferably be transmitted, such as the word “orchid”, or the name of the painter and of the painting, rather than a reproduction of an orchid or a reproduction of said painting.

By the term “sensory content” is meant a content which is capable of being transmitted in a telecommunications network, preferably in a digital form, and which appeals to the human senses such as those of hearing and sight. Thus, preferably, such a sensory content can be a visual content such as an image, or also a sequence of images, such as for example a video. II can also correspond to an auditory content such as a sound recording. II can also be an audiovisual content. Such a sensory content can be transmitted from the computer device to the user-side destination, or vice-versa, in a digital form.

In an embodiment of the present invention, the computer device to be authenticated is directly linked to a man-machine interface management unit, as shown in FIG. 1. In such an architecture, the computer device to be authenticated and the user interface management unit are directly linked.

A user 13 wishes to connect to a computer device 10 via a man-machine interface management unit 14. Such an architecture corresponds for example to an automated teller machine operated by a server 10. The present invention is described below in its application to server authentication.

In this architecture, FIG. 2 illustrates the different exchanges carried out during an authentication of the server 10. The user 13 provides to the unit 14 an identifier which travels to the server 10 via a message 201. The identifier sent in the message 201 can be for example a user name, ‘login’, or a client account number or also a file number, depending on the service offered by the server.

The server 10 manages an association of at least one sensory content with the received identifier. Based on this association, at step 202, the server determines at least one digital content corresponding to the identifier received in the message 201. Then, the server sends the determined digital content to the user interface management unit in the form of a message 203. The interface management unit 14 receives the digital content and is then able to supply this content to the user in the form of a sensory content.

In the present description, on the user side, when the received digital content is provided at the user level in the form of a sensory content, this means that the digital content is transcribed in a sensory form. Thus, a digital content corresponding to an image, respectively to a sound recording, is displayed on a screen, respectively broadcast via a loudspeaker. It can also be envisaged to use a haptic-type user interface.

Then, in an embodiment of the present invention, at a step 204 the user compares the sensory content that he knows and expects with the sensory content provided by the interface management unit 14. Based on this comparison, he is able to decide if the server is authenticated or not.

In order to determine such a digital content at step 202, the server can simply consider the sensory content associated with the user in its digital form.

In another embodiment, at this step 202, the server can determine the digital content to be sent to the user level using a developing determination parameter. Such an embodiment has an advantage against attacks based on ‘replay’. Preferably, such a parameter develops according to an development rule which is known both at the device level and at the user level. In such a case, the server can for example determiner the digital content by combining the sensory content associated with the user with a determination parameter. The digital content transmitted to the user then corresponds to a combined sensory content. In this context, the user interface management unit is capable of providing the user with the sensory content and the determination parameter separately. Thus, user-side, the server can advantageously be authenticated based on the sensory content, the secret of which is shared with the computer device, and based on the determination parameter, the development rule of which is known at the user level.

The determination parameter can advantageously be indexed to a time reference. It can for example vary with the time and/or the date on which the current authentication takes place. Thus it can be arranged that when the sensory content is a visual content, the determination parameter is displayed superimposed on the secret sensory content. In the case where the sensory content is an audio content, it can be arranged that the determination parameter is given to the user in audio form, following the sensory content for example.

Thus, for example, as a given image is associated with the user and the determination parameter corresponding to the date and time, during authentication the user views on a screen of the interface management unit the given image on which is superimposed the date and time corresponding approximately to the date and time at which the current authentication is carried out. The user recognizes the given image and determining that the determination parameter is correct, can conclude therefrom that the server is authenticated.

A determination parameter can be used, in an authentication system according to an embodiment of the present invention, as a selection parameter of a sensory content from a plurality of sensory contents associated with the considered user. In this case, it can advantageously be provided that the selection rule of a sensory content, used by the device, is also known at the user level, making it equally possible to carry out the authentication of the server based on the determination parameter.

The development of such a parameter allows the server to provide a different digital content at the user level as authentications progress, which makes it possible to protect against the replay of the authentication characteristics in case of attacks. In fact, in such an embodiment, the determination parameter and its developments are sufficiently known at the user level to allow the user to take this parameter into account for authenticating the server.

The present invention can also be implemented in an architecture such as that illustrated in FIG. 3. Such an architecture is based on a telecommunications network 41 which connects the server to be authenticated 10 with a user terminal 12. The latter, used by a user 13, can be a personal computer. The present invention covers all telecommunications networks allowing exchange of information between a terminal and a server 10. This type of architecture corresponds for example to an authentication of a server 10 through a web page.

In such a context, before providing confidential information to the server 10, the user wishes to ensure that the server to which he is connecting is the one to which he intended to connect. To this end, in an embodiment of the present invention, the server 10 and the user 13 share both a secret sensory content and a cryptographic characteristic, which allow the user to be protected against attacks originating from any rogue servers. In an embodiment of the present invention, prior to the exchanges of messages relating to the authentication, the server stores in a memory, an association of the identifier sent by the terminal user in the message 201 with a sensory content and with a cryptographic characteristic. When the server 10 has identified the user, it retrieves the corresponding content and cryptographic characteristic from the memory.

FIG. 4 illustrates an exchange of messages between the user terminal and the server 10 relating to the authentication of the server at the user level according to an embodiment of the present invention.

The user terminal 12 sends a message 201 to server 10 comprising an identifier of the user 13. On receiving this message, the server is able to determine a sensory content and a cryptographic characteristic associated with this user. Then, at step 202, the server 10 determines a digital content as described above with reference to FIG. 2. In such an architecture, the step 202 can also be implemented by using the determination parameter as described previously. Such a determination parameter can thus be used in combination with the sensory content associated with the user. Such a parameter can also be used for selecting a sensory content from a plurality of sensory contents associated with the user.

In a step 402, the server then encrypts the determined digital content using the cryptographic characteristic in order to obtain an encrypted digital content that it sends to the user terminal 12 via a message 403.

The user terminal 12 comprises means which are capable of decrypting the received digital content and for providing the user 13, at a step 405, with a sensory content corresponding to the received digital content. Then, at a step 204, the user can then compare the sensory content provided by the user terminal, with the previously known and expected sensory content. In the case where these sensory contents correspond, the user can continue the exchanges of information with the server in full confidence, as the server is authenticated. The digital content can also correspond to a sensory content combined with a determination parameter for example.

In such a context, the sensory content is preferably encrypted, respectively decrypted, by a secure encryption application, respectively a decryption application. These applications can advantageously be up- or downloaded in advance by the server 10 and by the user terminal 12.

Such an application can be integrated with an internet browser of the user terminal. It can allow decryption as well as providing the user with the decrypted combined sensory content. An application of this type therefore allows a high level of flexibility for the user. This type of application moreover makes it possible to protect against any fraudulent screen grabs. In fact, in such a context, for a sensory content corresponding to an image for example, it can advantageously be provided to display this image by zones only, so as to leave certain parts of the screen empty. It can in particular be provided firstly to display the image in the form of a scatter diagram, i.e. in a cloud form, then to clarify the image with each time the mouse cursor passes over the screen. By different methods of this type, well known to a person skilled in the art, the image is thus displayed only in a segmented manner.

Secure encryption and decryption applications of the Java type can advantageously be used in the context of the present invention. It can then be provided that such a Java application shares a secret key with the server. Other applications which can be executed independently of the internet browser and which can be implemented on the user's initiative can also be used in the context of the present invention. It can then be provided that a session key is supplied to such an application by the user.

A combination of the sensory content and the determination parameter aims to provide the user with a sensory content which is always substantially different at each authentication session, so that attacks aiming to retrieve the sensory content on the server, in order to present it to the user in its current form, are futile.

In an embodiment of the present invention implemented in an architecture such as that illustrated in FIG. 4, in the case where a secret key is shared between the server and the Java-type secure encryption application, a determination parameter can simply be inserted into the sensory content without substantially modifying this content. This is the same for an image on which the date and time of the authentication are superimposed, thus forming the combined sensory content. In such a case, a fraudster capturing the image which includes the superimposition of the date and time in order subsequently to present it to the user during a fraudulent authentication, is obliged to modify this image to update the date and time. However, the captured combined image is encrypted. As a result, the combined image which the fraudster can show to the user includes an incorrect time reference. The user is then able to detect the fraud before providing confidential information.

In the case where a less secure encryption is implemented, such as for example when a session key is used, it is advantageous to insert the determination parameter according to an information concealment technique. A person skilled in the art knows numerous methods for marking a digital file in a concealed manner, such as for example stenographic methods or also digital watermarking. Thus, even if a fraudster can retrieve the combined encrypted image, he is not able to detect the inserted determination parameter. In such a case, the decryption application has means of reading the thus-inserted determination parameter in order to provide this determination parameter to the user.

In an embodiment of the present invention, step /c/ of the user-level authentication method is implemented by the user himself. The present invention covers other embodiments in which step /c/ is carried out locally at the user level by a unit capable of taking the decision to authenticate the device.

The user terminal can for example comprise a unit capable of storing the sensory content at the user level in digital form. Thus if this sensory content is an image received through the postal service, the user can scan this image and store it on his user terminal. Step /c/ can then be carried out by a unit capable of ensuring that the digital file received from the server, and the digital file stored locally at the user level, correspond.

FIG. 5 illustrates a computer device 10 to be authenticated at the user level. It comprises a memory 50 for storing the association between the user and at least one sensory content. It also comprises a determination unit 51, capable of determining a digital content depending on the sensory content associated with said user. This digital content can be determined using the determination parameter as described previously. Such a device moreover comprises a transmission unit 52 capable of providing at the user level the digital content determined by the determination unit.

The FIG. 6 illustrates a user terminal 12 in an authentication system according to an embodiment of the present invention. It comprises a decryption unit 60 capable of decrypting a digital content in encrypted form received from the computer device, using the cryptographic characteristic the secret of which is shared with the device. It also comprises a user interface management unit 12 capable of providing the user with said digital content decrypted by the decryption unit, in the form of a sensory content.

1. A method for authenticating a computer device at the user level; an association of said user with at least one sensory content being known on the one hand, at the user level, and on the other hand, at the level of the computer device;
said method comprising the following steps:
/a/ at the level of the computer device, determining a digital content using the sensory content associated with said user;
/b/ from the computer device, providing at the user level the digital content determined in step /a/;
/c/ comparing the sensory content associated to the user with the digital content provided at step /b/ in order to decide to authenticate the computer device.

2. The method according to claim 1, wherein when the computer device manages a determination parameter developing according to a rule known at the user level, step /a/ is carried out moreover according to said determination parameter and the step /c/ is carried out moreover according to said development rule of the determination parameter.

3. The method according to claim 2, in which, at step /a/, the digital content is determined by combining the determination parameter with the sensory content associated with said user; wherein, at step /b/, the determination parameter and the sensory content are provided separately; and wherein step /c/ is carried out using on the one hand, the determination parameter and on the other hand, the sensory content, provided in step /b/.

4. The method according to claim 2, wherein the determination parameter is a time reference which develops according to a rule based on a time clock known at the level of the computer device and known at the user level.

5. The method according to claim 2, wherein, when the association associates a user with a plurality of sensory contents, at step /a/, the digital content is determined by selecting a sensory content from said plurality of sensory contents according to a selection rule based on the determination parameter, said selection rule being known at the level of the computer device and the user; and step /c/ is moreover carried out using said selection rule.

6. The method according to claim 1, when a telecommunications network links the computer device at the user level via a user terminal and when a secret cryptographic characteristic is known on the one hand at the user level and on the other hand at the level of the computer device;
at step /b/, the following steps:
encrypting the determined digital content using the cryptographic characteristic and sending the encrypted digital content from the computer device to user terminal;
decrypting said received encrypted digital content on the user terminal using the cryptographic characteristic; and
from the user terminal, providing at the user level said digital content obtained in the previous step.

7. The method according to claim 6, wherein the computer device manages a determination parameter which develops according to a rule known at the user level,
step /a/ is carried out by combining said determination parameter with the associated sensory content in a concealed manner according to a stenographic-type method;
step /c/ is carried out using said development rule of the determination parameter; and
the decrypting step carried out by the user terminal comprises a detection of the determination parameter in the combined sensory content so as to provide the decrypted sensory content and the determination parameter separately at the user level.

8. The method according to claim 1, wherein the sensory content is chosen from a group comprising an image, a sequence of images, an audio content and an audiovisual content.

9. A computer device intended to authenticate at a user level; an association of said user with at least one sensory content being known on the one hand at the user level and on the other hand at the level of the computer device;
said device comprising:
a memory for storing said association;
a determination unit capable of determining a digital content using the sensory content associated with said user;
a transmission device capable of providing, at the user level, the digital content determined by said determination unit.

10. (canceled)

11. A computer server capable of providing at least one service to a user, said server comprising a device according to claim 9.

12. (canceled)

13. A user terminal in an authentication system of a computer device at the user level; said computer device being linked to the user terminal by a telecommunications network; an association of said user with at least one sensory content and a secret cryptographic characteristic being known on the one hand at the user level and on the other hand at the level of the computer device;
said user terminal comprising authentication means of said computer device said means comprising:
means for sending a message comprising a user identifier;
means for receiving an encrypted digital content in response to said message;
means for decrypting capable of decrypting a digital content in encrypted form received from the computer device, using the cryptographic characteristic; and
means for user interface management unit capable of providing the user with said digital content decrypted by the decryption unit, in the form of a sensory content.

14.-17. (canceled)

18. A computer software product to be installed in a computer device, comprising instructions capable of implementing the method according to claim 1, during an execution of the programme by the processing means of the computer device.
